(19) United States
(12) Patent Application Publication
(10) Pub. No.: US 2026/0161571 A1
(43) Pub. Date: Jun. 11, 2026

(54) MACHINE LEARNING CACHE EVICTION VIA KEY DISSIMILARITY

(71) Applicant: QUALCOMM Incorporated, San Diego, CA (US)

(72) Inventors: Junyoung PARK, Palo Alto, CA (US); Dalton James JONES, Littleton, CO (US); Matthew James MORSE, Astoria, NY (US); Raghavv GOEL, San Diego, CA (US); Mingu LEE, San Diego, CA (US); Christopher LOTT, San Diego, CA (US)

(21) Appl. No.: 19/371,975

(22) Filed: Oct. 28, 2025

Related U.S. Application Data
(60) Provisional application No. 63/730,291, filed on Dec. 10, 2024.

(51) Int. Cl. G06F 12/121; G06N 3/045

(52) U.S. Cl. CPC G06F 12/121; G06N 3/045

(57) ABSTRACT

Certain aspects of the present disclosure provide techniques and apparatus for machine learning. In an example method, a memory associated with a generative machine learning model is accessed while data is processed using the generative machine learning model. The memory stores, for each token of a set of tokens for, or generated by, the generative machine learning model, a respective key tensor and a respective value tensor corresponding to the token. An average key tensor of the key tensors corresponding to the set of tokens is determined. A respective cosine similarity metric is generated for each key tensor, based on the key tensor and the average key tensor. At least one key tensor corresponding to at least one token of the set of tokens is evicted from the memory in response to determining that the respective cosine similarity metric for the at least one key tensor satisfies a condition.

### CROSS-REFERENCE TO RELATED APPLICATION

This application claims the benefit of U.S. Provisional Patent Application Ser. No. 63/730,291, filed Dec. 10, 2024, which is hereby incorporated by reference herein in its entirety for all applicable purposes.

### INTRODUCTION

### Field of the Disclosure

Aspects of the present disclosure relate to machine learning.

### DESCRIPTION OF RELATED ART

A wide variety of machine learning model architectures have been trained to perform an assortment of diverse tasks, including computer vision tasks, language tasks, classification and regression tasks, and the like. Recently, research has yielded substantial success in using large models (e.g., deep neural networks, large language models (LLMs), large vison models (LVMs), large multimodal models (LMMs), and the like) to process and generate output data. Often, machine learning models induce substantial computational expense in inferencing (e.g., generating model output). This expense is particularly problematic on resource-constrained devices (e.g., smartphones). Some attempts to mitigate the computational expense include caching intermediate values during inferencing for subsequent use. However, given the architectures of modern models, such caches rapidly become unacceptably large and often exceed available memory space.

### BRIEF SUMMARY

Certain aspects of the present disclosure provide a processor-implemented method. The processor-implemented method includes accessing a memory associated with a generative machine learning model while processing data using the generative machine learning model. The memory stores, for each token of a set of tokens for, or generated by, the generative machine learning model, a respective key tensor and a respective value tensor corresponding to the token. The processor-implemented method also includes determining an average key tensor of the key tensors corresponding to the set of tokens. The processor-implemented method also includes generating, for each key tensor, a respective cosine similarity metric based on the key tensor and the average key tensor. The processor-implemented method further includes evicting, from the memory, at least one key tensor corresponding to at least one token of the set of tokens in response to determining that the respective cosine similarity metric for the at least one key tensor satisfies a condition.

Certain aspects of the subject matter described in this disclosure provide a processing system for machine learning. The processing system includes one or more memories comprising processor-executable instructions and one or more processors coupled to the one or more memories. The one or more processors are configured to execute the processor-executable instructions and cause the processing system to: access a memory associated with a generative machine learning model while processing data using the generative machine learning model, the memory storing, for each token of a set of tokens for, or generated by, the generative machine learning model, a respective key tensor and a respective value tensor corresponding to the token; determine an average key tensor of the key tensors corresponding to the set of tokens; generate, for each key tensor, a respective cosine similarity metric based on the key tensor and the average key tensor; and evict, from the memory, at least one key tensor corresponding to at least one token of the set of tokens in response to determining that the respective cosine similarity metric for the at least one key tensor satisfies a condition.

Certain aspects of the present disclosure provide a processing system for machine learning. The processing system includes means for accessing a memory associated with a generative machine learning model while processing data using the generative machine learning model. The memory stores, for each token of a set of tokens for, or generated by, the generative machine learning model, a respective key tensor and a respective value tensor corresponding to the token. The processing system also includes means for determining an average key tensor of the key tensors corresponding to the set of tokens. The processing system also includes means for generating, for each key tensor, a respective cosine similarity metric based on the key tensor and the average key tensor. The processing system also includes means for evicting, from the memory, at least one key tensor corresponding to at least one token of the set of tokens in response to determining that the respective cosine similarity metric for the at least one key tensor satisfies a condition.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for cache management in machine learning models, according to some aspects of the present disclosure.

FIG. 2 depicts an example workflow for efficient token eviction during data processing in machine learning models, according to some aspects of the present disclosure.

FIG. 3 depicts an example of cosine-similarity-score-based token eviction in machine learning models, according to some aspects of the present disclosure.

FIG. 4 depicts an example cosine similarity score of a key tensor with an average key tensor, according to some aspects of the present disclosure.

FIG. 5 depicts an example process for cosine-similarity-score-based token eviction in machine learning models, according to some aspects of the present disclosure.

FIG. 6 depicts an example workflow for updating cosine-similarity-score-based token eviction in machine learning models, according to some aspects of the present disclosure.

FIG. 7 is a flow diagram depicting an example method for efficient token eviction during data processing in machine learning models, according to some aspects of the present disclosure.

FIG. 8 is a flow diagram depicting an example method for data eviction, according to some aspects of the present disclosure.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques for effective cache management, including cache eviction, in machine learning models are provided.

In a wide variety of machine learning model architectures, attention (e.g., self-attention) is used to generate model output. For example, many models (such as LLMs, LVMs, and the like) use transformer-based self-attention operations. Generating attention scores during data processing generally includes generating a set of intermediate data (e.g., tensors) for each element of the data (e.g., each token in an input sequence or in generated model output). For example, for each token, the model may compute a key tensor (also referred to in some aspects as the “keys”), a value tensor (also referred to in some aspects as the “values”), and a query tensor (also referred to in some aspects as the “queries”). As used herein, a “token” can generally correspond to any logical element of data. For example, in the case of LLMs, the tokens are generally words, phrases, characters, symbols, or portions thereof. In the case of LVMs, tokens are usually image patches or learned visual embeddings derived from groups of pixels, rather than individual pixels themselves. As used herein, a “key tensor” may refer to a data structure (e.g., a multi-dimensional array or vector) that encodes a projection of token embeddings used for computing attention weights in a neural network model, such as a transformer. As used herein, a “value tensor” may refer to the corresponding data structure that stores representation values or context features associated with each token. The “key tensor” and “value tensor” for each token may be generated during model inference and stored within a cache for subsequent reference when processing additional tokens.

Attention is generally computed for each token with respect to one or more other tokens based on the respective intermediate tensors for each token. For example, in the case of transformer-based LLMs, the next token prediction of causal transformers may be affected by past and current tokens. Additionally, in certain transformer-based LLMs, past tokens are generally immutable during the inferencing of the transformer and may be stored in memory to avoid re-computation.

Therefore, in some aspects, intermediate data caching can be used to reduce computational expense of the model (e.g., to cache intermediate data that will be used to process subsequent data). For example, in some models, the keys and values of one or more tokens may be cached (referred to in some aspects as “key-value (KV) caching”) for reuse in generating attention data for subsequent tokens, allowing for faster inferencing while also reducing computational expense of the model.

As used herein, a “cache” may generally refer to any memory used to store the intermediate data during processing. Similarly, “caching” data may refer to storing the data in any such memory. Further, “evicting” data from a cache may refer to removing or deleting the data from the cache, marking the corresponding memory address space as unused, overwriting the data in the cache, and the like.

While KV caches can significantly reduce the computational expense of generating model output, these caches grow rapidly and often become a severe memory bottleneck, particularly for devices with limited memory and/or when performing long-context generation (e.g., generating output based on a relatively large input prompt). For example, the memory consumed by the KV cache can exceed the footprint of the model itself (e.g., the static model memory used to hold parameters such as weights, embeddings, and normalization tensors that define the model at inference) (even for large models having millions or billions of parameters). In addition to the large memory consumption by the KV cache, the data transfer associated with a large cache size can impact the latency of the model inference.

Some approaches to mitigate these concerns include selective caching (e.g., where a subset of the intermediate data, such as data for a subset of the tokens, is cached, and/or where a subset of the intermediate data is evicted or removed from the cache during processing). In some aspects, removing the intermediate data associated with a given token may be referred to as “evicting” the token or as “token eviction.” For example, if the key tensor and value tensor of a given token are removed from the cache, it may be said that the given token was evicted from the cache.

In many transformer-based self-attention operations, certain tokens (e.g., KV pair(s)) may be given more weight during inferencing than other tokens, depending on the input query and position. In such transformer-based self-attention operations, the removal of tokens with negligible (e.g., zero or near zero) attention weights may not impact model output. Accordingly, some approaches to token eviction evaluate attention scores (or some variant thereof) of the tokens to decide which KV pair(s) to remove from the memory. For example, certain approaches, such as token omission via attention (TOVA) and heavy-hitter oracle (H₂O), compute importance scores of the prompt tokens derived from attention scores and evict the tokens with small scores prior to and during generation. H₂O sums all past attention scores while TOVA selects the last row of the attention matrix.

Existing attention-score-based eviction approaches, such as TOVA and H₂O, generally assume that the attention weights of all tokens are known at the time when evicting token(s). Thus, existing attention-score-based eviction approaches generally involve computing the full attention matrix (e.g., KV pairs) of the input prompt until generation. However, in certain cases, it may be impractical (or not possible) to compute the full attention matrix of an input prompt in resource-restricted settings, such as devices (e.g., smartphones) with limited resources (e.g., memory, bandwidth, compute, etc.).

Additionally, employing existing attention-score-based eviction approaches (e.g., TOVA and H₂O) in resource-restricted settings (e.g., smartphones) may result in loss of model performance when deploying transformer-based LLMs with long context inputs. For example, certain devices with limited resources may use block prompt processing, which may involve processing a small number of tokens (e.g., 64-128) at a time. However, when using block prompt processing, the keys and values under attention-score-based eviction approaches may collapse into a low rank state, thereby losing information. The resulting low rank state may be due to the receptive field of the attention weight computation (which couples tokens together through the softmax calculation) being more limited when block prompt processing is employed than when block prompt processing is not employed.

To address the aforementioned challenges, certain aspects of the present disclosure provide techniques for evicting tokens from the cache based on the cosine similarities among the keys corresponding to the tokens within the cache, rather than based on an attention score. For example, in some cases, the cosine similarity of a key tensor with respect to an average key tensor may be used as a proxy for the attention weight (or score) of the token corresponding to the key tensor. For instance, tokens with high attention weights tend to have low cosine similarity scores, and tokens with low attention weights tend to have high cosine similarity scores. That is, tokens with high attention weights may be oriented in a direction away from the average key tensor, and tokens with low attention weights may be oriented in a direction towards the average key tensor, where direction is measured by cosine similarity. As used herein, the term “average key tensor” may refer to a tensor whose individual elements each represent an arithmetic mean of the corresponding elements across the stored key tensors (e.g., in a KV cache), such that the average key tensor represents a centroid of the stored key tensors in vector space.

Accordingly, in some aspects described herein, token cache eviction may involve using a cosine similarity score as a metric for eviction of a token from the cache. In particular, as described in greater detail herein, token cache eviction may involve generating a cosine similarity metric for each key tensor (corresponding to a respective token) in the cache, based on the key tensor and an average key tensor of the key tensors in the cache. In some aspects, the cosine similarity metric for a given key tensor may include a score for the key tensor indicating a negative cosine similarity of the key tensor with the average key tensor, as defined in Equation 1 below. In other aspects, the cosine similarity metric for a given key tensor may include a score for the key tensor indicating a positive cosine similarity of the key tensor with the average key tensor, as defined in Equation 2 below.

$$negative cosine similarity = - {S}_{C} ( A , B ) := - cos θ \qquad ( 1 )$$

$$positive cosine similarity = {S}_{C} ( A , B ) := cos θ \qquad ( 2 )$$

In Equations 1 and 2, A is a key tensor (e.g., vector), B is an average key tensor (e.g., vector), and cos θ is defined in Equation 3 below:

$$cos θ = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \cdot \sqrt{{\sum }_{i = 1}^{n} {B}_{i}^{2}}} \qquad ( 3 )$$

In certain aspects, when the respective cosine similarity metric (e.g., positive cosine similarity score or negative cosine similarity score) for a given key tensor(s) corresponding to a token(s) satisfies a predetermined condition, the key tensor(s) and value tensor(s) corresponding to the token(s) may be evicted from the cache. For example, assuming the cosine similarity metric is a negative cosine similarity score, the predetermined condition may include being a lowest one or more negative cosine similarity scores. In another example, assuming the cosine similarity metric is a positive cosine similarity score, the predetermined condition may include being a highest one or more positive cosine similarity scores.

The techniques described herein for evicting tokens based on the cosine similarities among the keys may provide various technical advantages. For example, the cosine-similarity-based token eviction technique described herein can significantly reduce the KV cache size of transformer-based LLMs while significantly improving model performance, relative to existing attention-score-based eviction approaches. For instance, as noted, the cosine-similarity-based token eviction technique can reduce the size of the KV cache without losing information that may be used during model inference.

Additionally, compared to existing attention-score-based eviction approaches, the cosine-similarity-based token eviction technique allows for deployment of transformer-based LLMs (and other models) to resource-restricted devices (e.g., compute-restricted devices, memory-restricted devices, etc.). For example, the cosine-similarity-based token eviction technique described herein can be implemented with block prompt processing without compromising model performance, making the cosine-similarity-based token eviction technique suitable for on-device deployment, as well as other resource-restricted settings.

Additionally, the cosine-similarity-based token eviction technique described herein is a training-free technique that can be applied without additional training/fine-tuning of the model. As such, the cosine-similarity-based token eviction technique can be deployed without making additional modifications to the model.

Further, because the cosine-similarity-based token eviction technique described herein uses key tensors (as opposed to attention weights) to evict tokens, the cosine-similarity-based token eviction technique is more robust to the behavior of outlier query tokens compared to existing attention-score-based eviction approaches, such as TOVA. Additionally, since the average key tensor used within the cosine-similarity-based token eviction technique may be relatively constant over time, the cosine-similarity-based token eviction technique may also be more robust to issues associated with the receptive field of the attention weight computation when block prompt processing is employed, relative to existing attention-score-based eviction approaches. Additionally, because the cosine-similarity-based token eviction technique does not rely on attention weights, the cosine-similarity-based token eviction technique can be used with optimized attention kernels, such as FlashAttention, which typically do not materialize the attention weights, thereby increasing inference speed.

In some implementations, the cosine-similarity-based token eviction techniques described herein are specifically designed to exploit hardware characteristics of a computing platform, such as efficient utilization of a memory hierarchy, reduction in data transfer bandwidth between a neural processing unit (NPU), graphics processing unit (GPU), and main memory, or reduced cache-miss frequency during inference, as illustrative examples. By reducing the number of key and value tensors maintained concurrently, the cosine-similarity-based token eviction techniques described herein can decrease overall memory traffic and power consumption, thereby improving the efficiency of the computing device on which the machine learning model executes.

Additionally or alternatively, in some implementations, the cosine-similarity-based token eviction techniques described herein can be applied to certain technical applications, including image generation, speech recognition, audio synthesis, robot control, medical signal analysis, industrial process control, and other applications where reducing cache size directly contributes to faster, lower latency processing within these applications.

### Example Workflow for Cache Management in Machine Learning Models

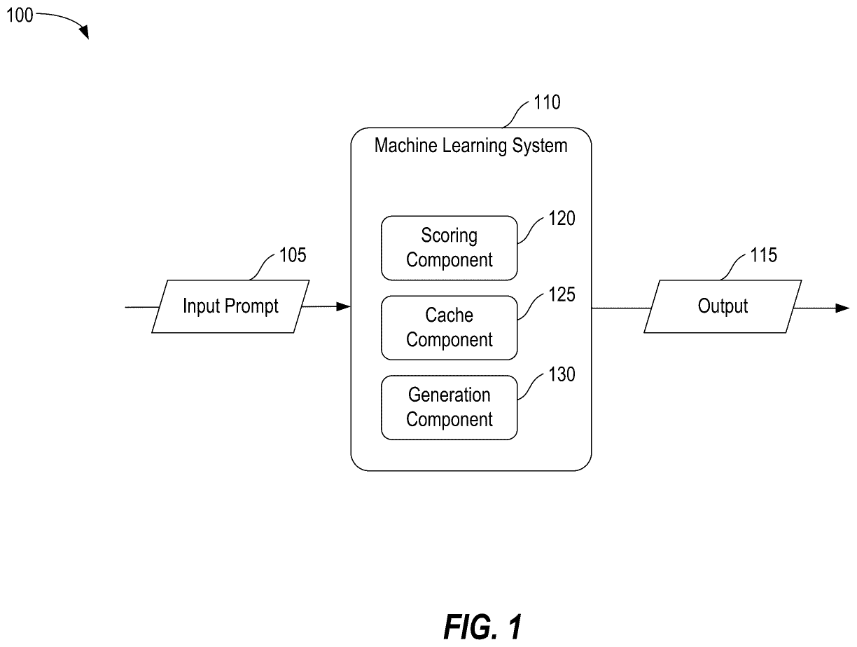

FIG. 1 depicts an example workflow 100 for cache management in machine learning models, according to some aspects of the present disclosure.

In the depicted workflow 100, a machine learning system 110 accesses an input prompt 105 to generate an output 115. As used herein, “accessing” data may generally include receiving, requesting, retrieving, obtaining, generating, collecting, to otherwise gaining access to the data. Although depicted as a discrete computing system for conceptual clarity, in some aspects, the operations of the machine learning system 110 may be implemented using hardware, software, or a combination of hardware and software, and may be distributed across any number and variety of systems.

In some aspects, the input prompt 105 generally includes an ordered sequence of elements (referred to as “tokens” in some aspects). The particular contents and format of the input prompt 105 may vary depending on the particular implementation. For example, if the machine learning system 110 includes an LLM, the input prompt 105 may include natural language text (e.g., where each element or token corresponds to a character, word (or portion thereof), or phrase). Similarly, the particular content and format of the output 115 may vary depending on the particular implementation. For example, the output 115 may include a natural language textual string, an image, and the like.

In some aspects, the machine learning system 110 may include or implement one or more machine learning models (e.g., generative machine learning models such as diffusion models, LLMs, LVMs, LMMs, and the like). In some aspects, as part of the machine learning model operations, the machine learning system 110 may perform one or more attention operations (e.g., using transformers) to process the input data. As discussed above, attention operations (such as self-attention operations) generally use learned weight tensors to project input features (e.g., the elements of the input prompt 105 or features generated therefrom) to a set of intermediate data (e.g., query (Q), key (K), and value (V) matrices). These intermediate data tensors can then be combined or evaluated to generate an attention score for each respective token (e.g., for each element of the input prompt 105) based on the data contained in the respective token as well as the data contained in one or more other tokens in the input prompt 105.

In some aspects, each token in the input prompt 105 (or features generated therefrom) attends to each other token using the attention mechanism. However, as discussed above, performing this attention introduces substantial computational overhead (e.g., quadratic compute time and high memory usage). Further, as discussed above, some attempts have been made to mitigate or reduce the computational expense by introducing caching of some or all of the intermediate attention data. However, such caches can grow to unrealistic sizes quickly (especially in long-context generation). In the illustrated workflow 100, therefore, the machine learning system 110 can perform selective cache eviction by evicting data associated with token(s) having a low impact on the attention output (e.g., based on cosine similarity scores).

Specifically, in the illustrated example, the machine learning system 110 includes a scoring component 120, a cache component 125, and a generation component 130. Although not included in the illustrated example, in some aspects, the machine learning system 110 may include other components, such as to train machine learning models (e.g., to learn the values for the matrices used to generate the queries, keys, and values, among other parameters). Although depicted as discrete components for conceptual clarity, in some aspects, the operations of the depicted components (and others not illustrated) may be combined or distributed across any number of components.

In the illustrated workflow 100, the scoring component 120 may be used to generate a cosine similarity metric for keys corresponding to tokens, as discussed above and in more detail below. For example, for each new token (e.g., for each token in the input prompt 105 and/or for each output token generated by the machine learning system 110), the scoring component 120 may generate a cosine similarity metric (e.g., positive cosine similarity score or negative cosine similarity score) for the key tensor corresponding to the token, based on the key tensor and an average key tensor of the key tensors in the cache, as discussed above and in more detail below.

The cache component 125 may generally be used to maintain the cache while processing data using the machine learning model. For example, in some aspects, the cache component 125 may store intermediate data (e.g., key tensors and value tensors) for tokens as the keys and values are generated (e.g., as new tokens are processed). In some aspects, for each new token, the cache component 125 may evaluate the cosine similarity metrics of tokens remaining in the cache (generated by the scoring component 120), and the cache component 125 may evict one or more tokens to maintain the size of the cache. For example, for each new token above a predetermined number of tokens associated with a cache budget or maximum cache size, the cache component 125 may evict one or more tokens having cosine similarity metrics that satisfy a predetermined condition (to make room to store the keys and values of the new token).

The generation component 130 may generally be used to generate new tokens for the output 115 of the machine learning system 110. For example, if the machine learning system 110 corresponds to or uses an LLM, the generation component 130 may generate the output tokens (e.g., words, phrases, characters, and the like) conditioned on the input prompt 105. In some aspects, each time a new token in the output 115 is generated, the scoring component 120 may similarly generate a respective cosine similarity metric for the key tensor corresponding to the token and may update the cache accordingly.

Specifically, in some aspects, the workflow 100 may begin with consumption or ingestion of the input prompt 105. In some aspects, the machine learning system 110 may ingest the input prompt 105 sequentially (e.g., one token at a time, in the order given in the input prompt 105). In some aspects, the machine learning system 110 may ingest the input prompt 105 using block prompt processing (e.g., a small number (or subset) of tokens at a time, in the order given in the input prompt 105).

In an illustrative example of input prompt ingestion, assume the input prompt 105 is N tokens long, the memory budget (e.g., the maximum number of tokens, or corresponding amount of memory, for which the associated keys and values may be retained in the cache) is W tokens, and the maximum size of the output 115 is M tokens. In this example, the machine learning system 110 may process the tokens of the input prompt 105 sequentially or using block prompt processing. The first W tokens of the input prompt 105 are processed to fill the cache to the cache's capacity (e.g., intermediate data, such as keys and values, for each of the W tokens is cached).

For each subsequent token among the remaining (N−W) tokens in the input prompt 105, the machine learning system 110 may determine which cached token(s) to evict using the cosine-similarity-based token eviction techniques described herein before adding the new token's intermediate data (e.g., keys and values) to the cache. For example, after W tokens (e.g., when the cache is full or a predetermined size is reached), the machine learning system 110 may process the remaining (N−W) tokens in the input prompt 105 (e.g., sequentially or using block prompt processing). For each new token in this remaining set, the scoring component 120 may compute, for each respective key tensor remaining in the cache, a respective cosine similarity metric based on the key tensor and an average key tensor of the remaining key tensors in the cache. The cache component 125 may then evict one or more tokens in the cache having cosine similarity metrics that satisfy a predetermined condition, and add the intermediate data (e.g., the keys and values) of the new token to the cache. This ingestion process can be repeated for all tokens in the input prompt 105. After ingesting the prompt, the cache contains data for W tokens (e.g., a subset of the N tokens in the prompt). As noted above, each key tensor is generated by the model's attention mechanism as a projection of a corresponding token embedding (e.g., via a learned linear transformation in a self-attention layer), and a corresponding value tensor is generated in parallel and stored together with the key tensor in the cache.

After ingesting the input prompt 105, the machine learning system 110 may generate the output 115 conditioned on the W tokens in the cache using the forward function of the machine learning model (e.g., the LLM). Specifically, the generation component 130 may generate a new token using an LLM based in part on the intermediate data stored in the cache. For each new token generated by the machine learning system 110, the cache component 125 can generate, for each respective key tensor remaining in the cache, a respective cosine similarity metric based on the key tensor and an average key tensor of the remaining key tensors in the cache. The cache component 125 can then evict one or more tokens in the cache having cosine similarity metrics that satisfy a predetermined condition, and add the intermediate data (e.g., the keys and values) of the newly generated token to the cache.

This generation process can be repeated until the generation component 130 generates an end-of-output token, until M tokens have been generated, or until some other termination criteria are met. The output 115 (comprising a sequence of generated tokens) can then be output by the machine learning system 110 (e.g., returned to the entity or application that provided the input prompt 105, output via a display or speaker, and the like). In this way, the machine learning system 110 can efficiently manage relatively small cache sizes with intelligent eviction decisions based on cosine similarity metrics of the cached keys.

Note that while the workflow 100 assumes that the cosine similarity scores of key tensors in the cache as well as the average key tensor are computed each time an eviction occurs, in some aspects, the cosine similarity scores as well as the average key tensor may be updated at lower frequencies to increase the efficiency (e.g., speed) of the token eviction. In such aspects, rather than updating the average key tensor at every eviction, the average key tensor may be maintained for (i) a predetermined period of time after an eviction, (ii) a predetermined number of tokens ingested or generated using the machine learning system after an eviction, (iii) a predetermined number of generation cycles of the machine learning system after an eviction, or (iv) any combination thereof. In some aspects, the predetermined period of time, the predetermined number of tokens, and/or the predetermined number of generation cycles may be based on a size of the input prompt 105, a maximum size of the cache, parameter(s) of the machine learning model, or any combination thereof.

Advantageously, the generation and use of cosine similarity metrics discussed herein may significantly improve performance of the machine learning system 110. In some aspects, the cosine-similarity-based token eviction can be implemented using existing generative artificial intelligence (AI) pipelines without relying on hardware modifications. Further, the disclosed techniques can be implemented as an online (e.g., runtime) algorithm that has a small effect on model generation latency. Additionally, as discussed above, aspects of the present disclosure enable improved performance (e.g., increased accuracy and/or reduced computational expense) for downstream tasks, particularly in limited-budget paradigms.

Moreover, certain aspects of the present disclosure can enable efficient management of the cache that allows for smaller memory footprint of the cache, allowing machine learning models (e.g., LLMs) to be deployed on devices having smaller memory capacity. Additionally or alternatively, the more intelligent cache evictions can enable accurate longer-context generation (e.g., generating output based on long input prompts 105) using the same or less cache size, as compared to some conventional approaches.

As used herein, tokens “for” the generative machine learning model may refer to input tokens that are provided to the generative machine learning model (e.g., tokens representing elements of an input prompt), while tokens “generated by” the generative machine learning model may refer to output tokens generated during inference. Unless otherwise indicated, references to a “set of tokens” may encompass one or both of these token types.

### Example Workflow for Efficient Token Eviction During Data Processing in Machine Learning Models

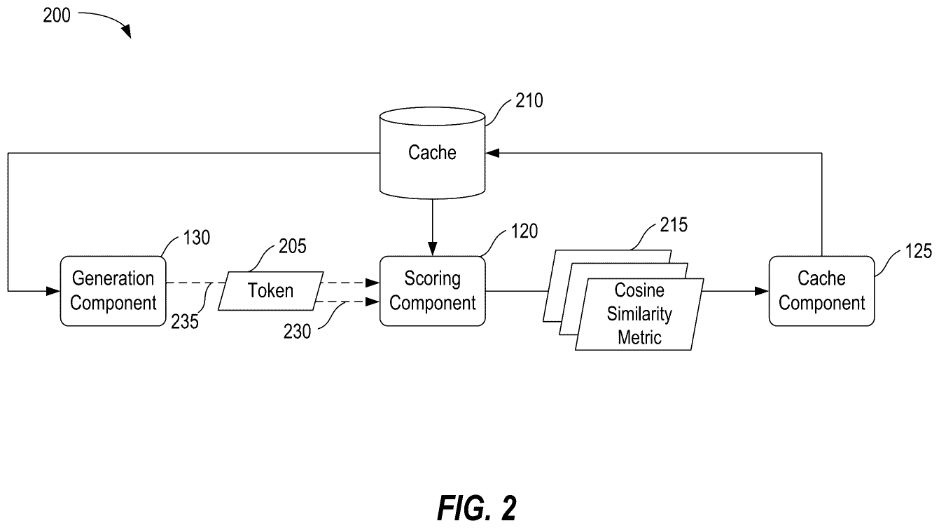

FIG. 2 depicts an example workflow 200 for efficient token eviction during data processing in machine learning models, according to some aspects of the present disclosure. Such data processing may include prompt ingestion and/or output generation. In some aspects, the workflow 200 is performed by a machine learning system, such as the machine learning system 110 of FIG. 1.

In the illustrated workflow 200, a token 205 is accessed by the scoring component 120. In some aspects, the token 205 may be an element from the input prompt to the machine learning model (e.g., the input prompt 105 of FIG. 1) as discussed above (e.g., as indicated by dotted arrow 230). For example, the token 205 may correspond to a character, word, phrase, or portion thereof in natural language text. In some aspects, as discussed above, the machine learning system evaluates or ingests the prompt sequentially. That is, the prompt may comprise a sequence of tokens with a defined order, and the machine learning system may ingest the tokens in the sequential order indicated by the prompt. In some aspects, as discussed above, the machine learning system evaluates or ingests the prompt using block prompt processing where a subset of tokens within the prompt are processed at a time.

In some aspects, the token 205 may be a new token (e.g., referred to in some aspects as an “output token”) that is generated by the generation component 130, e.g., based on the cache 210 (e.g., as indicated by dotted arrow 235). That is, the machine learning system may use the data in the cache 210 (e.g., the keys and values for the tokens from the prompt that were retained during ingestion and/or keys and values for tokens generated by the generation component 130) to condition the generation of the token 205 using the machine learning model (e.g., the LLM). In some aspects, the cache 210 may additionally or alternatively include data for one or more prior prompts to condition the token generation. Generally, the machine learning system may use any suitable operations or techniques to generate the token 205 based on the cache 210 (e.g., using standard LLM data generation architectures).

As illustrated in FIG. 2, the scoring component 120 further accesses a cache 210. The cache 210 generally includes intermediate data for one or more prior tokens. For example, as discussed above, the cache 210 may include the key tensor(s) and value tensor(s) of one or more prior token(s). That is, the cache 210 may include data for (i) token(s) that were earlier in the sequence of tokens, relative to the token 205, in the input prompt and/or (ii) token(s) that were previously generated by the generation component 130. In some aspects, the cache 210 may additionally or alternatively include data for token(s) from other prior prompts. In some aspects, as discussed above, the cache 210 may have a defined maximum size or a defined token budget that is less than the maximum size, such that the machine learning system periodically evicts data for token(s) as data for new token(s) is consumed.

In some aspects, the cache component 125 may trigger the scoring component 120 to generate cosine similarity metrics 215 for key tensors in the cache 210 when certain conditions are satisfied. For example, as discussed above, when the number of tokens stored within the cache 210 exceeds a predetermined number of tokens associated with a cache budget or maximum size of the cache 210, the cache component 125 may trigger the scoring component 120 to generate a cosine similarity metric 215 for each key tensor corresponding to a respective token reflected in the cache 210, based on the key tensor and an average key tensor of the key tensors in the cache 210. In some aspects, the scoring component 120 may use a score indicating a negative cosine similarity of the key tensor with the average key tensor as the cosine similarity metric 215, e.g., according to Equation 1. In some aspects, the scoring component 120 may use a score indicating a positive cosine similarity of the key tensor with the average key tensor as the cosine similarity metric 215, e.g., according to Equation 2.

In some aspects, the cache component 125 may access and evaluate the cosine similarity metrics 215 to determine whether to evict any data from the cache 210. As discussed above, the cache component 125 may identify one or more key tensors having the lowest negative cosine similarity scores or one or more key tensors having the highest positive cosine similarity scores, and the cache component 125 may evict the corresponding token(s) for the key tensor(s) from the cache 210 (e.g., removing the intermediate data, such as the key tensor(s) and the value tensor(s), for the evicted token(s)). In some aspects, this eviction clears room in the cache 210 to add the intermediate data for the newly ingested or newly generated token 205 (e.g., the key tensor and the value tensor for the token 205) to the cache 210.

In the illustrated workflow 200, this process may be repeated for each next token 205. In some aspects, once a token is evicted from the cache 210, the machine learning system may refrain from further analyzing or processing the evicted token. That is, subsequent operations (e.g., attention operations or other machine learning operations) may be performed based on the token(s) that remain in the cache 210, and evicted tokens may be ignored or discarded.

As discussed above, if the token 205 is an end-of-sentence token (or other token indicating the end of the generated output), the workflow 200 can terminate and the output (e.g., the generated sequence of tokens) can be provided as output of the model. As another example, in some aspects, if the number of generated tokens 205 meets defined criteria (e.g., a defined maximum number of output tokens for the model), the workflow 200 can similarly terminate.

Although depicted as discrete components for conceptual clarity, in some aspects, the operations of the generation component 130, scoring component 120, and cache component 125 (as well as others not illustrated) may be combined or distributed across any number of components.

Additionally, while various examples herein describe using a cosine similarity metric to measure the similarity between key tensors, in certain aspects, other similarity or distance metrics may alternatively or additionally be employed. Examples of such metrics include an inner-product similarity, Euclidean distance, Manhattan distance, and dot-product correlation, among others.

### Example Workflow for Cosine-Similarity-Score-Based Token Eviction in Machine Learning Models

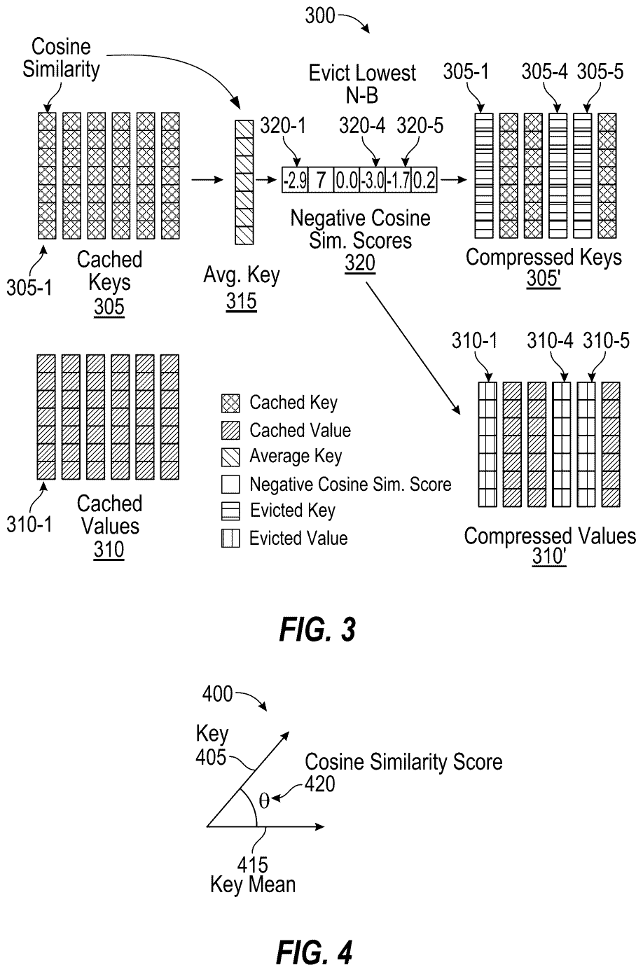

FIG. 3 depicts an example 300 of cosine-similarity-score-based token eviction in machine learning models, according to some aspects of the present disclosure. In some aspects, the example 300 is performed by a machine learning system, such as the machine learning system 110 of FIG. 1 and/or the machine learning system discussed above with reference to FIG. 2.

As illustrated, the cosine-similarity-score-based token eviction may involve computing an average key tensor 315 of the cached key tensors 305 (e.g., cached key tensors 305-1 to 305-6). The cosine-similarity-score-based token eviction may further involve generating, for each cached key tensor 305, a score indicative of the cosine similarity of the cached key tensor 305 with respect to the average key tensor 315. As discussed, cosine similarity is generally a measure of similarity between two non-zero vectors in vector space (e.g., n-dimensional space) and may be used to determine how similar two vectors are in terms of their direction in vector space. By way of example, with reference to FIG. 4, the cosine similarity score 420 of a key tensor 405 with the average key tensor 415 may be given by cos θ.

With reference to FIGS. 1-4, as discussed above, in some aspects, the cosine similarity score may be a score indicative of the negative cosine similarity of the cached key tensor 305 with respect to the average key tensor 315 (generally referred to herein as a “negative cosine similarity score”), as defined in Equation 1. In other aspects, the cosine similarity score may be a score indicative of the positive cosine similarity of the cached key tensor 305 with respect to the average key tensor 315 (generally referred to herein as a “positive cosine similarity score”), as defined in Equation 2. Here, in the depicted example, a negative cosine similarity score 320 is generated for each cached key tensor 305.

In the example 300, the cosine-similarity-score-based token eviction may further involve evicting one or more tokens having cosine similarity metrics that satisfy a predetermined condition. Assuming the cosine similarity metric is a negative cosine similarity score, such as negative cosine similarity score 320, the cosine-similarity-score-based token eviction may evict the lowest one or more scores 320. By way of example, assuming the number of tokens (N) is greater than a predefined number of tokens (B) corresponding to a predefined cache size, the cosine-similarity-score-based token eviction may evict N−B tokens having the lowest one or more scores 320. Here, in the example 300, three tokens (corresponding to cached key tensors 305-1, 305-4, and 305-5 and cached value tensors 310-1, 310-4, and 310-5) that have the lowest scores 320 are evicted from the cache, resulting in a cache with compressed keys 305′ and compressed values 310′.

Note, the compressed keys 305′ and the compressed values 310′ in FIG. 3 represent the cache after eviction of one or more key and value tensors corresponding to tokens having the lowest cosine similarity scores (e.g., tokens corresponding to cached key tensors 305-1, 305-4, and 305-5 and cached value tensors 310-1, 310-4, and 310-5). In this context, “compression” refers to the reduction in the amount of cached data that results from removing those tensors. Following eviction, the cache stores fewer key and value tensors and thereby occupies less memory, effectively yielding a compressed cache state. Additionally, note that the predefined number of tokens (B) may correspond to W tokens (e.g., the maximum number of tokens, or corresponding amount of memory, for which the associated keys and values may be retained in the cache), a subset of W tokens, or a dynamically adjustable portion of W tokens used for cache management operations.

### Example Process for Cosine-Similarity-Score-Based Token Eviction in Machine Learning Models

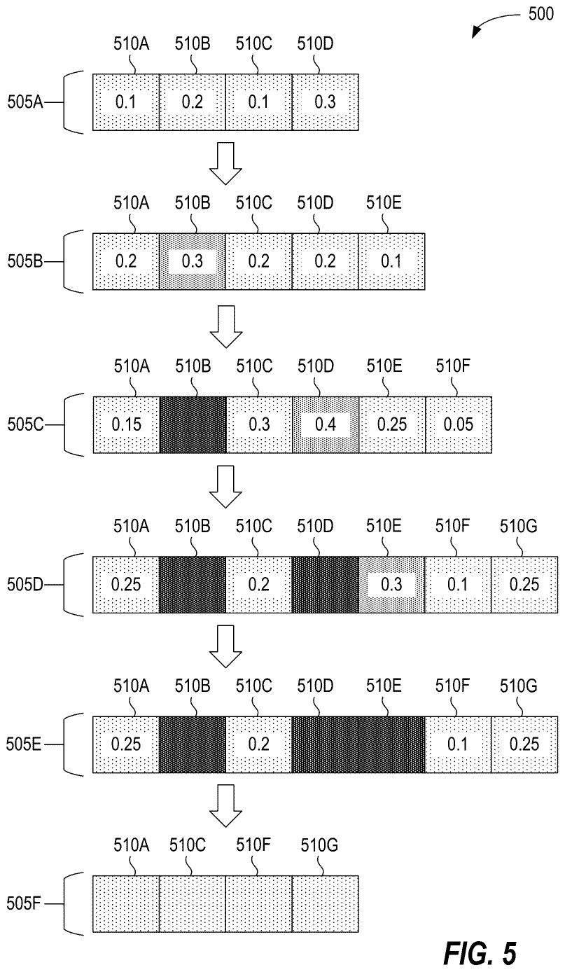

FIG. 5 depicts an example process 500 for cosine-similarity-score-based token eviction in machine learning models, according to some aspects of the present disclosure. In some aspects, the process 500 is performed by a machine learning system, such as the machine learning system 110 of FIG. 1 and/or the machine learning system discussed above with reference to FIG. 2.

With reference to FIGS. 1-5, the illustrated process 500 depicts the content of a machine learning model cache (e.g., the cache 210 of FIG. 2) while processing data using the model (e.g., while ingesting the prompt and/or while generating output tokens). Specifically, the illustrated process 500 depicts the contents of the cache at a sequence of steps 505A to 505F, where each step corresponds to the addition of a new token in the model (e.g., the ingestion of the next token in the input or the generation of the next token in the output).

As illustrated, at the step 505A, the cache includes four tokens 510A to 510D (that is, the cache includes data corresponding to four tokens, such as the keys and values of the four tokens). Further, in the illustrated example, each token 510A to 510D in the cache has a corresponding cosine similarity metric (e.g., the cosine similarity metric 215 of FIG. 2) determined based on the key tensor corresponding to the token 510 and average key tensor (e.g., average key tensor 315 of FIG. 3 or average key tensor 415 of FIG. 4) of the key tensors corresponding to tokens 510A to 510D. Specifically, at the step 505A, the token 510A has a positive cosine similarity score of 0.1, the token 510B has a positive cosine similarity score of 0.2, the token 510C has a positive cosine similarity score of 0.1, and the token 510D has a positive cosine similarity score of 0.3. While the depicted example uses positive cosine similarity scores for the cosine similarity metric, it should be noted that the process 500 can be implemented with negative cosine similarity scores for the cosine similarity metric.

As illustrated in the process 500, at the next step 505B, a new token 510E is added (e.g., ingested from the prompt or generated as output of the model). Based on this new token, the average key tensor is updated based on tokens 510A to 510E and the positive cosine similarity score of each token 510 in the cache is updated (e.g., using Equation 2 above). Specifically, at the step 505B, the token 510A has a new positive cosine similarity score of 0.2, the token 510B has a new positive cosine similarity score of 0.3, the token 510C has a new positive cosine similarity score of 0.2, the token 510D has a new positive cosine similarity score of 0.2, and the new token 510E has a new positive cosine similarity score of 0.1.

Further, as illustrated by the denser stippling at the step 505B, the machine learning system has identified the token 510B as having the highest positive cosine similarity score, and the machine learning system has decided to evict the token 510B (e.g., to make room in the cache for the data associated with the new token 510E).

At step 505C, as indicated by densest stippling, the token 510B has been evicted. Therefore, as illustrated, the machine learning system does not generate an updated cosine similarity score for the token 510B. Although the illustrated example depicts the token 510B remaining at step 505C for conceptual clarity, in some aspects of the present disclosure, evicting the token 510B may include removing or overwriting the associated data in the cache and discarding the token 510B for purposes of the machine learning model. That is, in some cases, the token 510B may be retained for future use (e.g., if multiple prompts are used to generate cosine similarity scores for future inputs and/or if the token 510B is a generated token that is part of the output), but is not used for further processing of the current prompt.

Further, as illustrated at the step 505C, a new token 510F is ingested or processed. Based on the new token 510F, the average key tensor is updated based on tokens 510A, 510C, 510D, 510E, and 510F, and the positive cosine similarity scores of the tokens 510A, 510C, 510D, 510E, and 510F in the cache are updated (e.g., using Equation 2 above). Specifically, at the step 505C, the token 510A has a new positive cosine similarity score of 0.15, the token 510C has a new positive cosine similarity score of 0.3, the token 510D has a new positive cosine similarity score of 0.4, the token 510E has a new positive cosine similarity score of 0.25, and the new token 510F has a new positive cosine similarity score of 0.05. Additionally, at the step 505C, as illustrated by the more dense stippling, the machine learning system has determined that the token 510D should be evicted, as the token 510D has the highest updated positive cosine similarity score.

At step 505D, as indicated by densest stippling, the token 510D has therefore been evicted. The token 510B remains evicted as well. Therefore, as illustrated, the machine learning system does not generate an updated positive cosine similarity score for the token 510D.

Further, as illustrated at the step 505D, another new token 510G is ingested or processed. Based on the new token 510G, the average key tensor is updated based on tokens 510A, 510C, 510E, 510F, and 510G, and the positive cosine similarity scores of tokens 510A, 510C, 510E, 510F, and 510G in the cache are updated (e.g., using Equation 2 above). Specifically, at the step 505D, the token 510A has a new positive cosine similarity score of 0.25, the token 510C has a new positive cosine similarity score of 0.2, the token 510E has a new positive cosine similarity score of 0.3, the token 510F has a new positive cosine similarity score of 0.1, and the new token 510G has a positive cosine similarity score of 0.25. Additionally, at the step 505D, as illustrated by the denser stippling, the machine learning system has determined that the token 510E should be evicted, as the token 510E has the highest positive cosine similarity score.

At step 505E, as indicated by densest stippling, the token 510E has therefore been evicted. The tokens 510B and 510D remain evicted as well. Therefore, as illustrated, the machine learning system does not generate an updated positive cosine similarity score for the token 510E.

As illustrated at the step 505F, the evicted tokens have been removed to illustrate the cache having four remaining tokens: the tokens 510A, 510C, 510F, and 510G. In this way, the machine learning system can ensure that the cache size remains within the defined memory space, and the most relevant tokens are retained for the generation process. For example, if the token 510G was the last token in the input prompt, the machine learning system may then use the cache (e.g., the tokens 510A, 510C, 510, and 510G) to condition the generation process (e.g., to generate one or more new tokens as output of the model).

### Example Workflow for Updating Cosine-Similarity-Score-Based Token Eviction in Machine Learning Models

As discussed above, in some aspects, rather than recomputing (i) the cosine similarity scores of the key tensors in the cache and (ii) the average key tensor each time an eviction occurs, the cosine similarity scores and the average key tensor may be updated at lower frequencies to increase the efficiency (e.g., speed) of the token eviction.

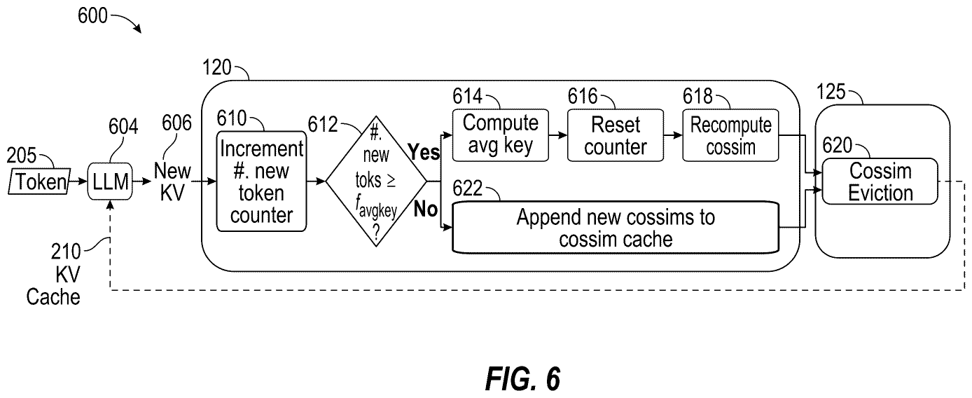

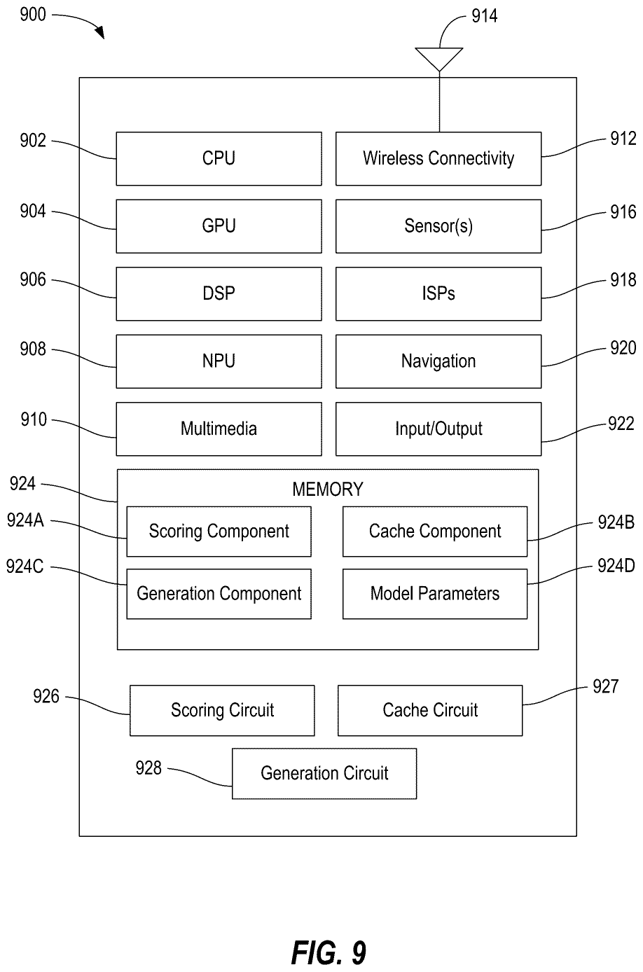

FIG. 6 depicts an example workflow 600 for updating cosine-similarity-score-based token eviction in machine learning models, according to some aspects of the present disclosure. In some aspects, the workflow 600 is performed by a machine learning system, such as the machine learning system 110 of FIG. 1, the machine learning system discussed above with reference to FIG. 2, and/or the processing system discussed below with reference to FIG. 9.

With reference to FIGS. 1-6 and 9, in the illustrated workflow 600, the scoring component 120 may use an average key update parameter (f_{avgkey}) to control the frequency of the average key tensor vector updates. For example, assuming f_{avgkey}=128, then the scoring component 120 may update the average key tensor at every 128 new tokens, thereby decreasing the frequency of updating the cosine similarity metrics for tokens within the cache. Within the update interval, the machine learning system may use cached cosine similarity metrics to perform token eviction, and the machine learning system may incrementally grow the cached cosine similarity metrics based on new tokens processed by the machine learning system. The value of f_{avgkey} may be based on a size of the input prompt 105, a maximum size of the cache, parameter(s) of the machine learning model, or any combination thereof.

By way of example, in the illustrated workflow 600, the machine learning model 604 may process a (new) token 205 and generate keys and values (e.g., new KV 606) for the token 205, based on intermediate data (e.g., key tensors and value tensors) for one or more prior tokens within the cache 210. At 610, the scoring component 120 may update a new token counter. For example, a value of the new token counter may be incremented by one for each new token 205.

At 612, the scoring component 120 determines whether the value of the new token counter is greater than the average key update parameter (f_{avgkey}). If the value of the new token counter is greater than or equal to f_{avgkey}, then the scoring component 120 (re)computes the average key tensor (614), resets the new token counter (e.g., reset to a value of zero) (616), and (re)computes the cosine similarity metrics for the tokens (618). On the other hand, if the value of the new token counter is less than f_{avgkey}, then the scoring component 120 generates the cosine similarity metric for the new token 205 and adds the generated cosine similarity metric to the cache 210 (622). As also illustrated in workflow 600, the cache component 125 may perform token eviction, based on the cosine similarity metrics (620), as discussed above.

Note that while the workflow 600 describes the average key update parameter (f_{avgkey}) being based on a number of tokens, in some aspects, the average key update parameter (f_{avgkey}) may be based on an amount of time and/or a number of generation cycles of the machine learning system (e.g., after an eviction).

### Example Method for Efficient Token Eviction During Data Processing in Machine Learning Models

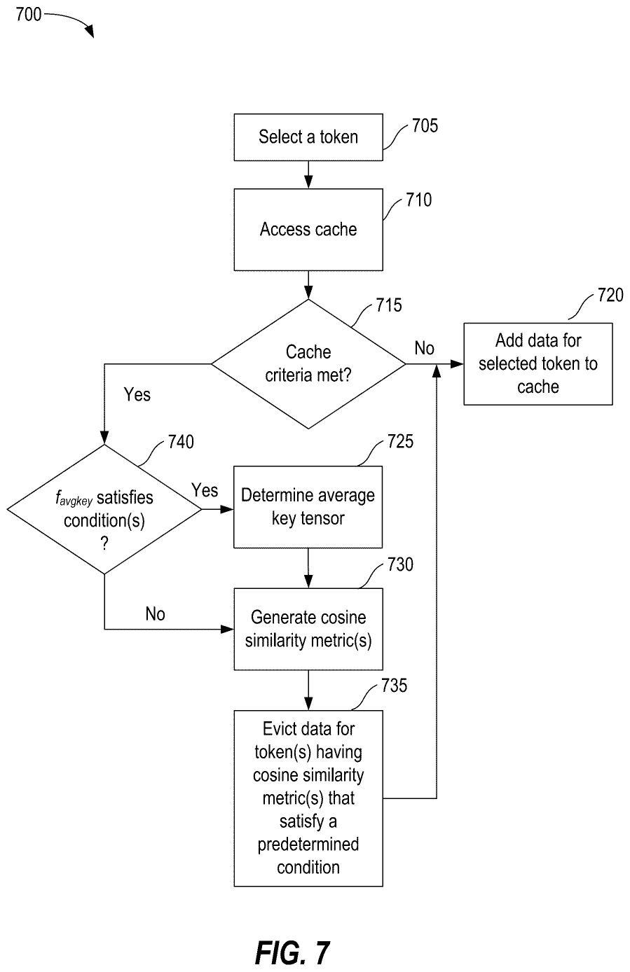

FIG. 7 is a flow diagram depicting an example method 700 for efficient token eviction during data processing in machine learning models, according to some aspects of the present disclosure. In some aspects, the method 700 is performed by a machine learning system, such as the machine learning system 110 of FIG. 1, the machine learning system discussed above with reference to FIGS. 2 and 6, and/or the processing system discussed below with reference to FIG. 9.

At block 705, the machine learning system selects a token (e.g., the token 205). As discussed, the token may be from an input prompt (e.g., the input prompt 105 of FIG. 1) or in generated model output (e.g., the output 115 of FIG. 1). In certain aspects, the operations at block 705 may involve performing the step at 610 of the workflow 600 (e.g., FIG. 6). In some implementations, the selection of the token may be based on the current operating stage of the model. For example, during an input prompt ingestion stage, the selected token may be one of the tokens within the input prompt. In some such examples, the machine learning system may read (e.g., sequentially or in small blocks) the tokens in the input prompt to populate and update a cache (e.g., cache 210) with the key and value tensors corresponding to the tokens. In other examples, during an output generation stage, the selected token may correspond to a newly generated token of the model output that is generated based on the intermediate data retained in the cache. Each time that the machine learning system generates a new token, this token may be selected for certain cache management operations described herein with respect to method 700. In some cases, the transition between the input prompt ingestion stage and the output generation stage may occur after the last token of the input prompt has been processed.

At block 710, the machine learning system accesses a cache (e.g., cache 210), e.g., to determine a number of tokens stored within the cache. At block 715, the machine learning system determines whether one or more cache criteria are met. For example, as discussed above, the machine learning system may determine whether the size of the cache meets or exceeds a defined threshold (e.g., a defined number of tokens). As discussed above, in some aspects, the defined threshold may be less than or equal to a maximum size for the cache. If the cache criteria are met at block 715, then the method 700 continues to block 740.

At block 740, the machine learning system determines whether an average key update parameter (e.g., f_{avgkey}) satisfies one or more conditions. As discussed (e.g., with reference to FIG. 6), in certain cases, the machine learning system may determine to (re)compute the average key tensor (at block 725) when the average key update parameter (e.g., f_{avgkey}) satisfies certain conditions based on a number of new tokens, a number of generation cycles, and/or an elapsed period of time, as illustrative examples. In certain aspects, the operations at block 740 may involve performing the step at 612 of the workflow 600.

If the average key update parameter satisfies the condition(s) (at block 740), then the method 700 proceeds to block 725. On the other hand, if the average key update parameter does not satisfy the one or more conditions (at block 740), then the method 700 proceeds to block 730 (e.g., the machine learning system may refrain from (re)computing the average key tensor at block 725).

At block 725, the machine learning system determines an average key tensor of the key tensors within the cache. In certain aspects, the operations at block 725 may involve performing one or more of the steps at 614 and 616 of the workflow 600.

At block 730, the machine learning system generates cosine similarity metrics for key tensors corresponding to tokens in the cache. In some aspects, the cosine similarity metrics include negative cosine similarity scores (e.g., as defined in Equation 1). In some aspects, the cosine similarity metrics include positive cosine similarity scores (e.g., as defined in Equation 2). In certain aspects, the operations at block 730 may involve performing the step at 618 or 622 of the workflow 600.

At block 735, the machine learning system evicts data for token(s) having cosine similarity metric(s) that satisfy a predetermined condition. For example, if the cosine similarity metrics include negative cosine similarity scores, then the machine learning system may evict one or more tokens having the lowest one or more scores. If the cosine similarity metrics include positive cosine similarity scores, then the machine learning system may evict one or more tokens having the highest one or more scores. In certain aspects, the operations at block 735 may involve performing the step at 620 of the workflow 600.

Returning to block 715, if the machine learning system determines that the criteria are not met (e.g., the cache is not yet full), the method 700 continues to block 720. At block 720, the machine learning system adds (intermediate) data for the newly selected token to the cache. For example, as discussed above, the machine learning system may add the key tensor and the value tensor for the selected token to the cache.

### Example Method for Data Eviction in Machine Learning Models

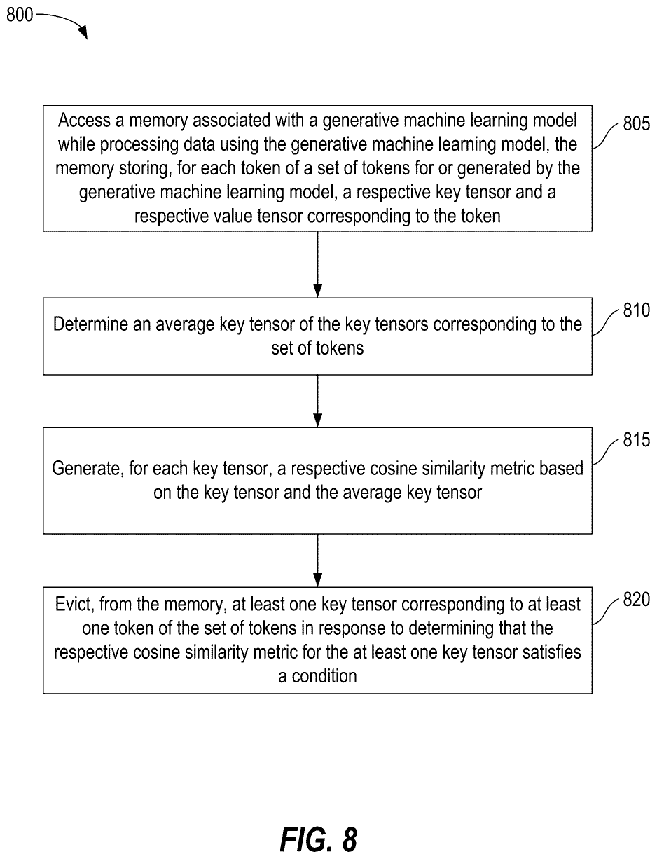

FIG. 8 is a flow diagram depicting an example method 800 for data eviction in machine learning models, according to some aspects of the present disclosure. In some aspects, the method 800 is performed by a machine learning system, such as the machine learning system 110 of FIG. 1, the machine learning system discussed above with reference to FIGS. 2 and 6, and/or the processing system discussed below with reference to FIG. 9.

With reference to FIGS. 1-7 and 9, at block 805, a memory (e.g., the cache 210 of FIG. 2) associated with a generative machine learning model (e.g., the machine learning model 604 of FIG. 6) is accessed while data is processed using the generative machine learning model. The memory stores, for each token of a set of tokens for (e.g., input tokens to), or generated by (e.g., output tokens from), the generative machine learning model, a respective key tensor (e.g., the cached key tensor 305 of FIG. 3) and a respective value tensor (e.g., the cached value tensor 310 of FIG. 3) corresponding to the token.

At block 810, an average key tensor (e.g., the average key tensor 315 of FIG. 3) of the key tensors corresponding to the set of tokens is determined.

At block 815, a respective cosine similarity metric (e.g., the cosine similarity metric 215 of FIG. 2 or the negative cosine similarity score 320 of FIG. 3) is generated for each key tensor, based on the key tensor and the average key tensor.

At block 820, at least one key tensor (e.g., the cached key tensors 305-1, 305-4, and 305-5 of FIG. 3) corresponding to at least one token of the set of tokens is evicted from the memory, in response to a determination that the respective cosine similarity metric for the at least one key tensor satisfies a condition.

In some aspects, the method 800 further includes evicting, from the memory, at least one value tensor (e.g., the cached value tensors 310-1, 310-4, and 310-5 of FIG. 3) corresponding to the at least one token of the set of tokens in response to determining that the respective cosine similarity metric for the at least one key tensor satisfies the condition.

In some aspects, generating the respective cosine similarity metric includes generating a respective score (e.g., the negative cosine similarity score 320 of FIG. 3) for each key tensor indicating a negative cosine similarity of the key tensor with the average key tensor. In such aspects, the condition includes being a lowest one or more scores. In some examples, the score for the key tensor corresponding to the evicted token is the lowest of the generated scores.

In some aspects, generating the respective cosine similarity metric includes generating a respective score for each key tensor indicating a positive cosine similarity of the key tensor with the average key tensor. In such aspects, the condition includes being a highest one or more scores. In some examples, the score for the key tensor corresponding to the evicted token is the highest of the generated scores.

In some aspects, evicting the at least one key tensor includes evicting the at least one key tensor corresponding to the at least one token upon determining that a number of tokens in the set of tokens is greater than a predefined number of tokens corresponding to a predefined memory size for the memory. In some aspects, a number of the at least one key tensor evicted from the memory is equal to a difference between the number of tokens and the predefined number of tokens. In some aspects, the predefined memory size is less than a maximum memory size for the memory.

In some aspects, the method 800 further includes, after evicting the at least one key tensor from the memory, updating the average key tensor based on remaining key tensors in the memory.

In some aspects, the method 800 further includes: (a) maintaining the average key tensor for at least one of: (i) a period of time after evicting the at least one key tensor from the memory, (ii) a number of tokens generated using the generative machine learning model after evicting the at least one key tensor from the memory, or (iii) a number of generation cycles of the generative machine learning model after evicting the at least one key tensor from the memory; and (b) updating the average key tensor based on remaining key tensors in the memory after at least one of the period of time has elapsed, the number of tokens has been generated, or the number of generation cycles has occurred. In some aspects, at least one of the period of time, the number of tokens, or the number of generation cycles is based on a size of an input prompt for the generative machine learning model, a maximum memory size for the memory, one or more parameters of the generative machine learning model, or any combination thereof.

In some aspects, the set of tokens is a superset of a plurality of tokens corresponding to an input prompt that is input to the generative machine learning model.

In some aspects, the set of tokens comprises at least one output token that is generated using the generative machine learning model.

In some aspects, the method 800 further includes refraining from evicting, from the memory, the at least one key tensor corresponding to the at least one token of the set of tokens in response to determining that the respective cosine similarity metric for the at least one key tensor does not satisfy the condition.

In some aspects, the generative machine learning model comprises a transformer-based neural network model.

Note that FIG. 8 is just one example of a method and other methods including fewer, additional, or alternative steps are possible consistent with this disclosure. For example, any of the features of certain aspects described with the workflows and/or methods herein—such as those of FIGS. 6-8—may be combined to perform data eviction in machine learning models consistent with the functionality described herein. Additionally, note that, in certain aspects, the workflow 600 of FIG. 6 may be illustrative implementation of the method 800 of FIG. 8. Similarly, in certain aspects, the method 700 of FIG. 7 may be an illustrative implementation of the method 800 of FIG. 8. Example Processing System for Machine Learning

FIG. 9 depicts an example processing system 900 configured to perform various aspects of the present disclosure, including, for example, the techniques and methods described with respect to FIGS. 1-8. In some aspects, the processing system 900 may correspond to a machine learning system. For example, the processing system 900 may correspond to the machine learning system 110 of FIG. 1 and/or the machine learning system discussed above with reference to FIGS. 2 and 6. Although depicted as a single system for conceptual clarity, in some aspects, as discussed above, the components described below with respect to the processing system 900 may be distributed across any number of devices or systems.

The processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., a partition of a memory 924).

The processing system 900 also includes additional processing components tailored to specific functions, such as a graphics processing unit (GPU) 904, a digital signal processor (DSP) 906, a neural processing unit (NPU) 908, a multimedia component 910 (e.g., a multimedia processing unit), and a wireless connectivity component 912.

An NPU, such as the NPU 908, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference). In some implementations, the NPU 908 is a part of one or more of the CPU 902, the GPU 904, and/or the DSP 906.

In some examples, the wireless connectivity component 912 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 912 is further coupled to one or more antennas 914.

The processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., global positioning system (GPS) or global navigation satellite system (GLONASS)) as well as inertial positioning system components.

The processing system 900 may also include one or more input and/or output devices 922, such as screens, touch-sensitive surfaces (including touch-sensitive displays), physical buttons, speakers, microphones, and the like.

In some examples, one or more of the processors of the processing system 900 may be based on an advanced reduced instruction set computing (RISC) machine (ARM) or fifth generation of RISC (RISC-V) instruction set.

The processing system 900 also includes a memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

In particular, in this example, the memory 924 includes a scoring component 924A, a cache component 924B, and a generation component 924C. Although not depicted in the illustrated example, the memory 924 may also include other components, such as a training component used to train or update machine learning model(s). Though depicted as discrete components for conceptual clarity in FIG. 9, the illustrated components (and others not depicted) may be collectively or individually implemented in various aspects.

Further, in the illustrated example, the memory 924 also includes model parameters 924D (e.g., parameters of one or more machine learning models, such as an LLM). Although not depicted in the illustrated example, in some aspects, the memory 924 may include other data such as a training data for the machine learning model(s), prior prompt(s) processed by the machine learning model(s), prior outputs generated by the machine learning model(s), and the like.

The processing system 900 further comprises a scoring circuit 926, a cache circuit 927, and a generation circuit 928. The depicted circuits, and others not depicted (such as an inferencing circuit), may be configured to perform various aspects of the techniques described herein.

The scoring component 924A and/or the scoring circuit 926 (which may correspond to the scoring component 120 of FIGS. 1-2 and 6) may be used to generate cosine similarity metrics for tokens stored in a machine learning model cache, as discussed above. For example, the scoring component 924A and/or the scoring circuit 926 may use Equation 1 or Equation 2 to generate the cosine similarity metrics when a new token is ingested (e.g., generated by the model or selected from the input).

The cache component 924B and/or the cache circuit 927 may be used to selectively add and evict tokens from the cache based on cosine similarity metric scores, as discussed above. For example, the cache component 924B and/or the cache circuit 927 may, when the cache is full and data for a new token is ready to be added to the cache, evict the data associated with the token(s) having cosine similarity metric(s) that satisfy a predetermined condition, as discussed above.

The generation component 924C and/or the generation circuit 928 may be used to generate machine learning model output (e.g., the output 115 of FIG. 1), as discussed above. For example, the generation component 924C and/or the generation circuit 928 may condition the model (e.g., an LLM) based on the cache to generate the output tokens sequentially.

Though depicted as separate components and circuits for clarity in FIG. 9, the scoring circuit 926, the cache circuit 927, and the generation circuit 928 may collectively or individually be implemented in other processing devices of the processing system 900, such as within the CPU 902, the GPU 904, the DSP 906, the NPU 908, and the like.

Generally, the processing system 900 and/or components thereof may be configured to perform the methods described herein.

Notably, in other aspects, aspects of the processing system 900 may be omitted, such as where the processing system 900 is a server computer or the like. For example, the multimedia component 910, the wireless connectivity component 912, the sensor processing units 916, the ISPs 918, and/or the navigation processor 920 may be omitted in other aspects. Further, aspects of the processing system 900 may be distributed between multiple devices.

Although certain examples herein generally refer to generative machine learning models, the techniques described herein may be implemented in connection with a variety of technical applications, including but not limited to: image/video processing (e.g., image classification, image compression/decompression, image segmentation or depth prediction, image reconstruction or enhancement (e.g., de-noising), frame prediction); audio and speech processing (e.g., speech recognition, synthesis, source separation); robotics and autonomous control (e.g., where model output controls actuators or navigation paths); medical signal analysis (including diagnosis based on physiological signals or controlling imaging devices); industrial process control (e.g., providing an output for controlling an industrial process, such as in manufacturing); and protein modeling applications (e.g., determining the structure of a given protein, generating data defining a protein, etc.); among others. In each of these applications, the cosine-similarity-based token eviction techniques described herein can reduce latency and memory usage of the inferencing engine implementing the underlying neural network.

Each of the following examples illustrates a type of data represented by the input tokens and output tokens, and the corresponding processing task performed by the generative machine learning model to generate the output tokens.

For image or video processing, the input tokens may be image or video data represented as pixel patches, encoded pixel-intensity vectors, or feature map embeddings derived from convolutional or transformer encoder layers. The output tokens may be generated or reconstructed pixel patches, feature vectors, segmentation masks, depth maps, or compressed image blocks, as illustrative examples. The processing task may involve generating, classifying, segmenting, reconstructing, or enhancing image/video data, for example, de-noising, de-blurring, super-resolution, or frame prediction. When applied to image processing applications, the cosine-similarity-based token eviction techniques described herein can reduce the amount of memory for storing attention keys during pixel-wise or patch-wise generation.

With respect to audio and speech processing, the input tokens may be audio samples, spectral coefficients representing temporal segments of an audio waveform, or text characters or phonemes. The output tokens may be generated or predicted audio samples, frequency-domain coefficients, or recognized text tokens corresponding to transcribed words. The processing task may include speech recognition, speech synthesis, speaker separation, or audio compression. When applied to audio and speech processing, the cosine-similarity-based token eviction techniques described herein can enable real-time generation or transcription on resource constrained devices by reducing the KV cache size during inferencing over long temporal windows.

With respect to robotics and autonomous control, the input tokens may be sensor data streams such as images, light detection and ranging (LiDAR) point clouds, inertial measurement unit (IMU) samples, or joint position encodings, represented as sequential tokens. The output tokens may be control vectors representing actuator commands, navigation waypoints, or motion-planning updates. The processing task may involve generating control signals for a robot or autonomous vehicle based on sensor perception. When applied to robotics and autonomous control, the cosine-similarity-based token eviction techniques described herein can enable low-latency inference within hardware controllers having constrained memory resources.

With respect to medical signal analysis, the input tokens may be physiological measurement samples (e.g., electrocardiogram (ECG), electroencephalogram (EEG), electromyography (EMG), blood oxygen readings) or medical image pixels representing tissue structures. The output tokens may be diagnostic indicators, probability scores, annotated image regions, or control parameters for imaging or therapeutic equipment. The processing task may involve diagnosing a medical condition or controlling imaging hardware (e.g., ultrasound beam steering, magnetic resonance imaging (MRI) sequence selection). When applied to medical signal analysis, the cosine-similarity-based token eviction techniques described herein can lower computational latency and memory usage in embedded medical device processors, enabling and/or improving real-time operation.

With respect to industrial process control, the input tokens may be sensor readings from a manufacturing or chemical process (e.g., temperature, pressure, flow rate, vibration spectra, etc.) encoded as sequential tokens. The output tokens may be predicted process states, anomaly indicators, or actuators control set-points. The processing task may involve controlling or optimizing an industrial process using learned correlations between sensor inputs and control outputs. When applied to industrial process control, the cosine-similarity-based token eviction techniques described herein may allow deployment on low-power industrial controllers with limited (or at least reduced) memory (e.g., RAM).

With respect to protein modeling applications, the input tokens may be amino acid sequence tokens, structural coordinate embeddings, or other biochemical descriptors representing portions of a protein or molecule. The output tokens may be predicted secondary or tertiary structural parameters, such as residue-to-residue distances or torsion angles. The processing task may involve determining or generating molecular structures from sequence information. When applied to protein modeling applications, the cosine-similarity-based token eviction techniques described herein may reduce cache size, thereby accelerating inference of long sequences, enabling larger protein contexts to be processed on available system memory.

With respect to natural language and multimodal generation applications, the input tokens may be textual prompt tokens, optionally combined with image, video, and/or audio embeddings in multimodal models. The output tokens may be generated text, image pixels, or multimodal outputs conditioned on the prompt. The processing task may include generating, translating, or summarizing content based on natural language input. When applied to natural language and multimodal generation applications, the cosine-similarity-based token eviction techniques may improve (e.g., increase) increase throughput and reduce memory consumption during long context generation.

### Example Clauses

Implementation examples are described in the following numbered clauses:

Clause 1: A method for machine learning, comprising: accessing a memory associated with a generative machine learning model while processing data using the generative machine learning model, the memory storing, for each token of a set of tokens for, or generated by, the generative machine learning model, a respective key tensor and a respective value tensor corresponding to the token; determining an average key tensor of the key tensors corresponding to the set of tokens; generating, for each key tensor, a respective cosine similarity metric based on the key tensor and the average key tensor; and evicting, from the memory, at least one key tensor corresponding to at least one token of the set of tokens in response to determining that the respective cosine similarity metric for the at least one key tensor satisfies a condition.

Clause 2: The method of Clause 1, further comprising evicting, from the memory, at least one value tensor corresponding to the at least one token of the set of tokens in response to determining that the respective cosine similarity metric for the at least one key tensor satisfies the condition.

Clause 3: The method according to any of Clauses 1-2, wherein generating the respective cosine similarity metric comprises generating a respective score for each key tensor indicating a negative cosine similarity of the key tensor with the average key tensor.

Clause 4: The method of Clause 3, wherein the condition comprises being a lowest one or more scores.

Clause 5: The method according to any of Clauses 1-2, wherein generating the respective cosine similarity metric comprises generating a respective score for each key tensor indicating a positive cosine similarity of the key tensor with the average key tensor.

Clause 6: The method of Clause 5, wherein the condition comprises being a highest one or more scores.

Clause 7: The method according to any of Clauses 1-6, wherein the at least one key tensor corresponding to the at least one token is evicted from the memory upon determining that a number of tokens in the set of tokens is greater than a predefined number of tokens corresponding to a predefined memory size for the memory.

Clause 8: The method of Clause 7, wherein a number of the at least one key tensor evicted from the memory is equal to a difference between the number of tokens and the predefined number of tokens.

Clause 9: The method according to any of Clauses 7-8, wherein the predefined memory size is less than a maximum memory size for the memory.

Clause 10: The method according to any of Clauses 1-9, further comprising, after evicting the at least one key tensor from the memory, updating the average key tensor based on remaining key tensors in the memory.

Clause 11: The method according to any of Clauses 1-10, further comprising: maintaining the average key tensor for at least one of: (i) a period of time after evicting the at least one key tensor from the memory, (ii) a number of tokens generated using the generative machine learning model after evicting the at least one key tensor from the memory, or (iii) a number of generation cycles of the generative machine learning model after evicting the at least one key tensor from the memory; and updating the average key tensor based on remaining key tensors in the memory after at least one of the period of time has elapsed, the number of tokens has been generated, or the number of generation cycles has occurred.

Clause 12: The method of Clause 11, wherein at least one of the period of time, the number of tokens, or the number of generation cycles is based on a size of an input prompt for the generative machine learning model, a maximum memory size for the memory, one or more parameters of the generative machine learning model, or any combination thereof.

Clause 13: The method according to any of Clauses 1-12, wherein the set of tokens is a superset of a plurality of tokens corresponding to an input prompt that is input to the generative machine learning model.

Clause 14: The method according to any of Clauses 1-13, wherein the set of tokens comprises at least one output token that is generated using the generative machine learning model.

Clause 15: The method according to any of Clauses 1-14, further comprising refraining from evicting, from the memory, the at least one key tensor corresponding to the at least one token of the set of tokens in response to determining that the respective cosine similarity metric for the at least one key tensor does not satisfy the condition.

Clause 16: The method according to any of Clauses 1-15, wherein the generative machine learning model comprises a transformer-based neural network model.

Clause 17: A processing system comprising: a memory comprising processor-executable instructions; and one or more processors coupled to the one or more memories and configured to execute the processor-executable instructions and cause the processing system to perform a method in accordance with any of Clauses 1-16.

Clause 18: A processing system comprising means for performing a method in accordance with any of Clauses 1-16.

Clause 19: A non-transitory computer-readable medium comprising computer-executable instructions that, when executed by one or more processors of a processing system, cause the processing system to perform a method in accordance with any of Clauses 1-16.

Clause 20: A computer program product embodied on a computer-readable storage medium comprising code for performing a method in accordance with any of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, means for accessing, means for determining, means for generating, means for evicting, means for updating, means for maintaining, and/or means for refraining may include one or more processors, such as one or more of the CPU 902, the GPU 904, the NPU 908, the DSP 906 and/or other processing components of FIG. 9.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning comprising:
one or more memories comprising processor-executable instructions; and
one or more processors coupled to the one or more memories and configured to execute the processor-executable instructions and cause the processing system to:
access a memory associated with a generative machine learning model while processing data using the generative machine learning model, the memory storing, for each token of a set of tokens for, or generated by, the generative machine learning model, a respective key tensor and a respective value tensor corresponding to the token;
determine an average key tensor of the key tensors corresponding to the set of tokens;
generate, for each key tensor, a respective cosine similarity metric based on the key tensor and the average key tensor; and
evict, from the memory, at least one key tensor corresponding to at least one token of the set of tokens in response to determining that the respective cosine similarity metric for the at least one key tensor satisfies a condition.

2. The processing system of claim 1, wherein the one or more processors are configured to execute the processor-executable instructions and further cause the processing system to evict, from the memory, at least one value tensor corresponding to the at least one token of the set of tokens in response to determining that the respective cosine similarity metric for the at least one key tensor satisfies the condition.

3. The processing system of claim 1, wherein to generate the respective cosine similarity metric, the one or more processors are configured to execute the processor-executable instructions and further cause the processing system to generate a respective score for each key tensor indicating a negative cosine similarity of the key tensor with the average key tensor.

4. The processing system of claim 3, wherein the condition comprises being a lowest one or more scores.

5. The processing system of claim 1, wherein to generate the respective cosine similarity metric, the one or more processors are configured to execute the processor-executable instructions and further cause the processing system to generate a respective score for each key tensor indicating a positive cosine similarity of the key tensor with the average key tensor.

6. The processing system of claim 5, wherein the condition comprises being a highest one or more scores.

7. The processing system of claim 1, wherein to evict the at least one key tensor, the one or more processors are configured to execute the processor-executable instructions and further cause the processing system to evict the at least one key tensor corresponding to the at least one token upon determining that a number of tokens in the set of tokens is greater than a predefined number of tokens corresponding to a predefined memory size for the memory.

8. The processing system of claim 7, wherein a number of the at least one key tensor evicted from the memory is equal to a difference between the number of tokens and the predefined number of tokens.

9. The processing system of claim 7, wherein the predefined memory size is less than a maximum memory size for the memory.

10. The processing system of claim 1, wherein the one or more processors are configured to execute the processor-executable instructions and further cause the processing system to, after evicting the at least one key tensor from the memory, update the average key tensor based on remaining key tensors in the memory.

11. The processing system of claim 1, wherein the one or more processors are configured to execute the processor-executable instructions and further cause the processing system to:
maintain the average key tensor for at least one of: (i) a period of time after evicting the at least one key tensor from the memory, (ii) a number of tokens generated using the generative machine learning model after evicting the at least one key tensor from the memory, or (iii) a number of generation cycles of the generative machine learning model after evicting the at least one key tensor from the memory; and
update the average key tensor based on remaining key tensors in the memory after at least one of the period of time has elapsed, the number of tokens has been generated, or the number of generation cycles has occurred.

12. The processing system of claim 11, wherein at least one of the period of time, the number of tokens, or the number of generation cycles is based on a size of an input prompt for the generative machine learning model, a maximum memory size for the memory, one or more parameters of the generative machine learning model, or any combination thereof.

13. The processing system of claim 1, wherein the set of tokens is a superset of a plurality of tokens corresponding to an input prompt that is input to the generative machine learning model.

14. The processing system of claim 1, wherein the set of tokens comprises at least one output token that is generated using the generative machine learning model.

15. The processing system of claim 1, wherein the one or more processors are configured to execute the processor-executable instructions and further cause the processing system to refrain from evicting, from the memory, the at least one key tensor corresponding to the at least one token of the set of tokens in response to determining that the respective cosine similarity metric for the at least one key tensor does not satisfy the condition.

16. The processing system of claim 1, wherein the generative machine learning model comprises a transformer-based neural network model.

17. A processor-implemented method for machine learning, comprising:
accessing a memory associated with a generative machine learning model while processing data using the generative machine learning model, the memory storing, for each token of a set of tokens for, or generated by, the generative machine learning model, a respective key tensor and a respective value tensor corresponding to the token;
determining an average key tensor of the key tensors corresponding to the set of tokens;
generating, for each key tensor, a respective cosine similarity metric based on the key tensor and the average key tensor; and
evicting, from the memory, at least one key tensor corresponding to at least one token of the set of tokens in response to determining that the respective cosine similarity metric for the at least one key tensor satisfies a condition.

18. The processor-implemented method of claim 17, further comprising evicting, from the memory, at least one value tensor corresponding to the at least one token of the set of tokens in response to determining that the respective cosine similarity metric for the at least one key tensor satisfies the condition.

19. The processor-implemented method of claim 17, wherein generating the respective cosine similarity metric comprises generating a respective score for each key tensor indicating a negative cosine similarity of the key tensor with the average key tensor.

20. The processor-implemented method of claim 19, wherein the condition comprises being a lowest one or more scores.

21. The processor-implemented method of claim 17, wherein generating the respective cosine similarity metric comprises generating a respective score for each key tensor indicating a positive cosine similarity of the key tensor with the average key tensor.

22. The processor-implemented method of claim 21, wherein the condition comprises being a highest one or more scores.

23. The processor-implemented method of claim 17, wherein evicting the at least one key tensor comprises evicting the at least one key tensor corresponding to the at least one token upon determining that a number of tokens in the set of tokens is greater than a predefined number of tokens corresponding to a predefined memory size for the memory.

24. The processor-implemented method of claim 23, wherein a number of the at least one key tensor evicted from the memory is equal to a difference between the number of tokens and the predefined number of tokens.

25. The processor-implemented method of claim 23, wherein the predefined memory size is less than a maximum memory size for the memory.

26. The processor-implemented method of claim 17, further comprising, after evicting the at least one key tensor from the memory, updating the average key tensor based on remaining key tensors in the memory.

27. The processor-implemented method of claim 17, further comprising:
maintaining the average key tensor for at least one of: (i) a period of time after evicting the at least one key tensor from the memory, (ii) a number of tokens generated using the generative machine learning model after evicting the at least one key tensor from the memory, or (iii) a number of generation cycles of the generative machine learning model after evicting the at least one key tensor from the memory; and
updating the average key tensor based on remaining key tensors in the memory after at least one of the period of time has elapsed, the number of tokens has been generated, or the number of generation cycles has occurred.

28. The processor-implemented method of claim 27, wherein at least one of the period of time, the number of tokens, or the number of generation cycles is based on a size of an input prompt for the generative machine learning model, a maximum memory size for the memory, one or more parameters of the generative machine learning model, or any combination thereof.

29. The processor-implemented method of claim 17, wherein the set of tokens is a superset of a plurality of tokens corresponding to an input prompt that is input to the generative machine learning model.

30. The processor-implemented method of claim 17, wherein the set of tokens comprises at least one output token that is generated using the generative machine learning model.

31. The processor-implemented method of claim 17, further comprising refraining from evicting, from the memory, the at least one key tensor corresponding to the at least one token of the set of tokens in response to determining that the respective cosine similarity metric for the at least one key tensor does not satisfy the condition.

32. The processor-implemented method of claim 17, wherein the generative machine learning model comprises a transformer-based neural network model.

33. A processing system for machine learning, comprising:
means for accessing a memory associated with a generative machine learning model while processing data using the generative machine learning model, the memory storing, for each token of a set of tokens for, or generated by, the generative machine learning model, a respective key tensor and a respective value tensor corresponding to the token;
means for determining an average key tensor of the key tensors corresponding to the set of tokens;
means for generating, for each key tensor, a respective cosine similarity metric based on the key tensor and the average key tensor; and
means for evicting, from the memory, at least one key tensor corresponding to at least one token of the set of tokens in response to determining that the respective cosine similarity metric for the at least one key tensor satisfies a condition.
